(19) United States
(12) Patent Application Publication
(10) Pub. No.: US 2026/0228265 A1
(43) Pub. Date: Aug. 6, 2026

(54) METHOD AND ELECTRONIC DEVICE FOR GENERATING OUTPUT DATA OF LANGUAGE MODEL BASED ON TARGET INFORMATION

(71) Applicant: Sionic AI Inc, Seoul (KR)

(72) Inventors: Woomyoung Park, Seoul (KR); Jin Hyung Park, Seoul (KR); Sukhyun Ko, Seoul (KR)

(21) Appl. No.: 19/213,863

(22) Filed: May 20, 2025

(30) Foreign Application Priority Data
Feb. 6, 2025 (KR) 10-2025-0014957

(51) Int. Cl. G06F 16/335; G06F 16/334; G06F 16/35

(52) U.S. Cl. CPC G06F 16/335; G06F 16/3347; G06F 16/35

(57) ABSTRACT

A method for generating output data of a language model based on target information, performed by at least one processor, includes obtaining from a user a first query, generating, within a data structure that includes a plurality of similar response data groups classified based on similarity, a first target response data group corresponding to the first query, and acquiring output data for the first query from an LLM-based generation model based on the first query and the first target response data group.

### CROSS-REFERENCE TO RELATED APPLICATION

This application claims priority to Korean Patent Application No. 10-2025-0014957, filed in the Korean Intellectual Property Office on Feb. 6, 2025, the entire contents of which are hereby incorporated by reference.

### BACKGROUND

### Field

The present disclosure relates to a method for generating output data of a language model based on target information and to an electronic device.

### Description of Related Art

In the field of natural language processing, techniques have been developed that optimize the performance of a large language model (LLM) to meet user demands. In addition, as LLMs have become capable of processing multi-modality data, there is an increasingly diverse demand for tasks that extract specific information within specific images.

However, because the sentence-generation process of an LLM repeatedly selects the next token, there is a problem in that, when the LLM receives a query it does not know, the probability that incorrect information (hallucination) will be output increases. Furthermore, there is a problem in that, for information that has not been trained in the LLM (e.g., the latest information or confidential information), the LLM cannot provide an accurate answer.

On the other hand, there is a desire to use an LLM model that can derive accurate answers based on their own proprietary internal data. However, if an individual company attempts to obtain a proprietary model by fine-tuning an LLM having an enormous number of parameters, there is a difficulty in that a massive amount of training data and training resources are required for such fine-tuning.

Accordingly, there is a demand for the development of a language-model-based technology that, based on target information, accurately generates output data.

### SUMMARY

The present disclosure provides a method and an electronic device for generating output data of a language model based on target information so as to solve the problems described above.

The present disclosure may be implemented in various forms, including methods, apparatuses (systems), and non-transitory computer-readable recording media storing computer-readable instructions.

According to an example of the present disclosure, a method for generating output data of a language model based on target information, performed by at least one processor, may include obtaining from a user a first query, generating, within a data structure that includes a plurality of similar response data groups classified based on similarity, a first target response data group corresponding to the first query, and acquiring output data for the first query from an LLM-based generation model based on the first query and the first target response data group.

In some implementations, the method further includes generating the data structure, wherein generating the data structure may include calculating a similarity between a particular piece of response data included in the data structure and each of a remaining plurality of pieces of response data included in the data structure and generating the plurality of similar response data groups by comparing the calculated similarity with a predetermined threshold.

In some implementations, calculating the similarity may include generating embedding vectors for the particular piece of response data and for each of the plurality of pieces of response data, and calculating the similarity between an embedding vector for the particular piece of response data and an embedding vector for each of the plurality of pieces of response data.

In some implementations, calculating the similarity may include inputting a pair of pieces of response data into an LLM-based neural network model to calculate the similarity through an output of the neural network model.

In some implementations, the method further includes generating the data structure, wherein generating the data structure may include generating an embedding vector for each of a plurality of pieces of response data included in the data structure, generating one or more reference vectors having a same dimension as the embedding vector, calculating a hash value for each of the plurality of pieces of response data based on the embedding vector and the one or more reference vectors, and classifying, based on the calculated hash value, response data having an identical hash value into an identical similar response data group.

In some implementations, calculating the hash value for each of the plurality of pieces of response data may include performing a dot product operation between an embedding vector for a particular piece of response data and each of the one or more reference vectors, and generating a hash value having a length corresponding to a number of the one or more reference vectors according to a result of the dot product operation.

In some implementations, the plurality of similar response data groups included in the data structure are each stored in association with corresponding metadata.

In some implementations, the metadata may include one or more main keywords included in a particular similar response data group.

In some implementations, the one or more main keywords are obtained by calculating a term frequency of words in each piece of response data included in the particular similar response data group and extracting words whose calculated term frequency is greater than or equal to a threshold term frequency.

In some implementations, the one or more main keywords are obtained by inputting response data included in the particular similar response data group into an LLM-based neural network model to derive keywords.

In some implementations, the data structure further may include a basic response data group, and wherein generating the first target response data group may include determining a first response data group corresponding to the first query from among the basic response data group, determining a candidate similar response data group for the first query based on metadata for each of the plurality of similar response data groups, determining a second response data group corresponding to the first query from among the candidate similar response data group, and generating the first target response data group including the first response data group and the second response data group.

In some implementations, the method further includes obtaining from the user a second query subsequent to the first query, creating a new query by concatenating the first query and the second query, generating a second target response data group corresponding to the new query, and acquiring output data for the new query from the LLM-based generation model based on the new query, the first target response data group, and the second target response data group.

In some implementations, a non-transitory computer-readable recording medium storing computer-readable instructions, wherein the instructions, when executed by at least one processor, cause the at least one processor to obtain from a user a first query, generate, within a data structure that includes a plurality of similar response data groups classified based on similarity, a first target response data group corresponding to the first query, and acquire output data for the first query from an LLM-based generation model based on the first query and the first target response data group.

In some implementations, an electronic device, may include a memory, and at least one processor connected to the memory and configured to execute computer-readable instructions stored in the memory, wherein the at least one processor is configured to obtain from a user a first query, generate, within a data structure that includes a plurality of similar response data groups classified based on similarity, a first target response data group corresponding to the first query, and acquire output data for the first query from an LLM-based generation model based on the first query and the first target response data group.

In some implementations, the at least one processor is configured to calculate a similarity between a particular piece of response data included in the data structure and each of a remaining plurality of pieces of response data included in the data structure, and generate the plurality of similar response data groups by comparing the calculated similarity with a predetermined threshold thereby generating the data structure.

In some implementations, the at least one processor is configured to generate embedding vectors for the particular piece of response data and for each of the plurality of pieces of response data, and calculate the similarity between an embedding vector for the particular piece of response data and an embedding vector for each of the plurality of pieces of response data.

In some implementations, the at least one processor is configured to generate an embedding vector for each of a plurality of pieces of response data included in the data structure, generate one or more reference vectors having a same dimension as the embedding vectors, calculate a hash value for each of the plurality of pieces of response data based on the embedding vector and the one or more reference vectors, and classify, based on the calculated hash value, response data having an identical hash value into an identical similar response data group thereby generating the data structure.

In some implementations, the at least one processor is configured to obtain from the user a second query subsequent to the first query, create a new query by concatenating the first query and the second query, generate a second target response data group corresponding to the new query, and acquire output data for the new query from the LLM-based generation model based on the new query, the first target response data group, and the second target response data group.

According to one or more aspects of the present disclosure, even if a large number of documents in similar forms are registered, because those many documents are stored via an appropriate data structure, a language-model-based answer for a specific query can be efficiently output.

Further, according to one or more aspects of the present disclosure, when a subsequent query is obtained following a preceding query, it is possible to reduce the probability of an inaccurate output from the LLM model and provide a more accurate answer by generating target information to produce more accurate output data within the given context.

The effects of the present disclosure are not limited to the effects mentioned above, and other effects not mentioned will be clearly understood by those of ordinary skill in the art to which the present disclosure pertains from the description of the claims.

### BRIEF DESCRIPTION OF THE DRAWINGS

Embodiment(s) of the present disclosure will be described below with reference to the accompanying drawings, in which like reference numerals refer to like elements, but are not limited thereto.

FIG. 1 illustrates, by way of example, an electronic device for generating output data of a language model based on target information.

FIG. 2 is a schematic diagram illustrating a configuration in which an information processing system is connected so as to be capable of communicating with a plurality of user terminals, in connection with data processing.

FIG. 3 is a block diagram illustrating internal configurations of a user terminal and an information processing system.

FIG. 4 is a diagram for describing a method for generating output data of a language model based on target information.

FIGS. 5A and 5B illustrate, by way of example, pieces of response data included in a particular similar response data group.

FIG. 6 is a diagram for describing a method for generating a data structure.

FIG. 7 is a diagram illustrating, by way of example, a process of generating a target response data group.

FIG. 8 is a diagram for describing a method for generating output data for a second query subsequent to a first query.

### DETAILED DESCRIPTION

Hereinafter, example details for the practice of the present disclosure will be described in detail with reference to the accompanying drawings. However, in the following description, detailed descriptions of well-known functions or configurations will be omitted if it may make the subject matter of the present disclosure rather unclear.

In the accompanying drawings, the same or corresponding components are assigned the same reference numerals. In addition, in the following description of various examples, duplicate descriptions of the same or corresponding components may be omitted. However, even if descriptions of components are omitted, it is not intended that such components are not included in any example.

Advantages and features of the disclosed examples and methods of accomplishing the same will be apparent by referring to examples described below in connection with the accompanying drawings. However, the present disclosure is not limited to the examples disclosed below, and may be implemented in various forms different from each other, and the examples are merely provided to make the present disclosure complete, and to fully disclose the scope of the disclosure to those skilled in the art to which the present disclosure pertains.

The terms used herein will be briefly described prior to describing the disclosed example(s) in detail. The terms used herein have been selected as general terms which are widely used at present in consideration of the functions of the present disclosure, and this may be altered according to the intent of an operator skilled in the art, related practice, or introduction of new technology. In addition, in specific cases, certain terms may be arbitrarily selected by the applicant, and the meaning of the terms will be described in detail in a corresponding description of the example(s). Accordingly, the terms used in this disclosure should be defined based on the meaning of the term and the overall content of the present disclosure, rather than simply the name of the term.

As used herein, the singular forms “a,” “an,” and “the” are intended to include the plural forms as well, unless the context clearly indicates the singular forms. Further, the plural forms are intended to include the singular forms as well, unless the context clearly indicates the plural forms. Further, throughout the description, when a portion is stated as “comprising (including)” a component, it is intended as meaning that the portion may additionally comprise (or include or have) another component, rather than excluding the same, unless specified to the contrary.

Further, the term “module” or “unit” used herein refers to a software or hardware component, and “module” or “unit” performs certain roles. However, the meaning of the “module” or “unit” is not limited to software or hardware. The “module” or “unit” may be configured to be in an addressable storage medium or configured to play one or more processors. Accordingly, as an example, the “module” or “unit” may include components such as software components, object-oriented software components, class components, and task components, and at least one of processes, functions, attributes, procedures, subroutines, program code segments, drivers, firmware, micro-codes, circuits, data, database, data structures, tables, arrays, and variables. Furthermore, functions provided in the components and the “modules” or “units” may be combined into a smaller number of components and “modules” or “units”, or further divided into additional components and “modules” or “units.”

A “module” or “unit” may be implemented as a processor and a memory, or may be implemented as a circuit (circuitry). Terms such as circuit and circuitry may refer to circuits in hardware, but may also refer to circuits in software. The “processor” should be interpreted broadly to encompass a general-purpose processor, a central processing unit (CPU), a microprocessor, a digital signal processor (DSP), a neural processing unit (NPU), a controller, a microcontroller, a state machine, etc. Under some circumstances, the “processor” may refer to an application-specific integrated circuit (ASIC), a programmable logic device (PLD), a field-programmable gate array (FPGA), etc. The “processor” may refer to a combination for processing devices, e.g., a combination of a DSP and a microprocessor, a combination of a plurality of microprocessors, a combination of one or more microprocessors in conjunction with a DSP core, or any other combination of such configurations. In addition, the “memory” should be interpreted broadly to encompass any electronic component that is capable of storing electronic information. The “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. The memory is said to be in electronic communication with a processor if the processor can read information from and/or write information to the memory. The memory integrated with the processor is in electronic communication with the processor.

In addition, terms such as first, second, A, B, (a), (b), etc. used in the following examples are only used to distinguish certain components from other components, and the nature, sequence, order, etc. of the components are not limited by the terms.

In addition, in the following examples, if a certain component is stated as being “connected,” “combined” or “coupled” to another component, it is to be understood that there may be yet another intervening component “connected,” “combined” or “coupled” between the two components, although the two components may also be directly connected or coupled to each other.

In addition, as used in the following examples, “comprise” and/or “comprising” does not foreclose the presence or addition of one or more other elements, steps, operations, and/or devices in addition to the recited elements, steps, operations, or devices.

Hereinafter, various examples of the present disclosure will be described in detail with reference to the accompanying drawings.

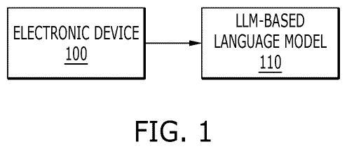

FIG. 1 illustrates, by way of example, an electronic device 100 for generating output data of a language model based on target information. Referring to FIG. 1, the electronic device 100 may generate output data by using an LLM-based language model 110 based on a database having a particular data structure.

An LLM (Large Language Model) is an artificial neural network model that has been trained in advance on a vast amount of text data. The LLM-based language model 110 is composed of a large-scale neural network structure configured to perform natural language processing (NLP) tasks, and it can generate responses to basic queries based on data learned previously.

The electronic device 100 may include a memory and at least one processor. However, the configuration of the electronic device 100 is not limited to the above. The electronic device 100 may further include at least one other component in addition to the above-described components. For example, the electronic device 100 may further include a communication circuit (or communication module) for communication with an external electronic device.

The processor may be connected to the memory and configured to execute at least one computer-readable program included in the memory. For example, the processor may execute software (or a program) to control at least one other component (e.g., hardware or software component) of the electronic device 100 connected to the processor, and to perform various data processing or computations. According to one or more implementations, as at least part of the data processing or computations, the processor may load commands or data received from another component (e.g., the communication circuit) into volatile memory, process commands or data stored in the volatile memory, and store the resulting data in nonvolatile memory.

The memory may store various data used by at least one component (e.g., the processor) of the electronic device 100. Such data may include input data or output data related to software (or programs), for example, and instructions related thereto. The memory may include volatile memory or nonvolatile memory.

At least one program executed by the processor may include instructions associated with generating output data using a language model. In the following, it will be described that the processor performs a certain function, but this is for convenience of explanation, and it can be understood that the function performed by the processor is in effect the processor executing instructions in at least one program stored in the memory.

In FIG. 1, the LLM-based language model 110 is shown as being located outside the electronic device 100. However, depending on the implementation/configuration, the LLM-based language model 110 may be stored in the memory of the electronic device 100.

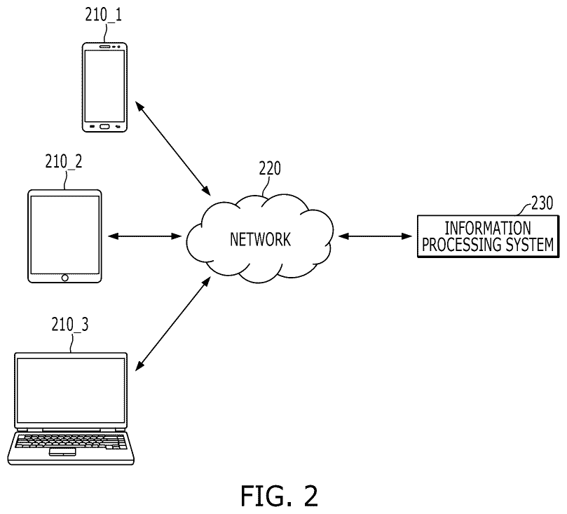

FIG. 2 is a schematic diagram illustrating a configuration in which an information processing system 230 is connected so as to be capable of communicating with a plurality of user terminals 210_1, 210_2, and 210_3, in connection with data processing. The information processing system 230 may include system(s) capable of providing a data processing service (for example, a language-model-based service). In an example, the information processing system 230 may include one or more server devices and/or databases, or one or more distributed computing devices and/or distributed databases based on a cloud computing service, all of which can store, provide, and execute computer-executable programs (for example, downloadable applications) and data related to the data processing service. For example, the information processing system 230 may include separate system(s) (for example, servers) for data processing services.

The data processing service, etc. provided by the information processing system 230 may be provided to users via a data processing application, a web browser application, etc. installed in each of the plurality of user terminals 210_1, 210_2, and 210_3.

The plurality of user terminals 210_1, 210_2, 210_3 may communicate with the information processing system 230 via a network 220. The network 220 may be configured to enable communication between the plurality of user terminals 210_1, 210_2, 210_3 and the information processing system 230. Depending on the installation environment, the network 220 may include, for example, a wired network such as Ethernet, a wired home network (power line communication), telephone line communication devices, RS-serial communication, a wireless network such as a mobile communication network, a WLAN (Wireless LAN), Wi-Fi, Bluetooth, ZigBee, or a combination thereof. The method of communication is not limited, and it may include not only communication using communication networks (for example, mobile communication networks, wired Internet, wireless Internet, broadcasting networks, satellite networks, etc.) that the network 220 may include but also short-range wireless communication between user terminals 210_1, 210_2, 210_3.

For example, the plurality of user terminals 210_1, 210_2, 210_3 may send, via the network 220, requests for data processing or commands associated with a user request for data processing to the information processing system 230, and the information processing system 230 may receive them.

In FIG. 2, a mobile phone terminal 210_1, a tablet terminal 210_2, and a PC terminal 210_3 are shown as examples of user terminals, but the user terminals 210_1, 210_2, 210_3 are not limited thereto; a user terminal may be any computing device capable of wired and/or wireless communication and running a data processing application. For example, a user terminal may include a smartphone, a mobile phone, a navigation device, a computer, a notebook, a digital broadcast terminal, a PDA (Personal Digital Assistant), a PMP (Portable Multimedia Player), a tablet PC, a game console, a wearable device, an IoT (Internet of Things) device, a VR (virtual reality) device, an AR (augmented reality) device, etc. In addition, although three user terminals 210_1, 210_2, 210_3 are shown in FIG. 2 as communicating with the information processing system 230 via the network 220, they are not limited thereto, and a different number of user terminals may be configured to communicate with the information processing system 230 via the network 220.

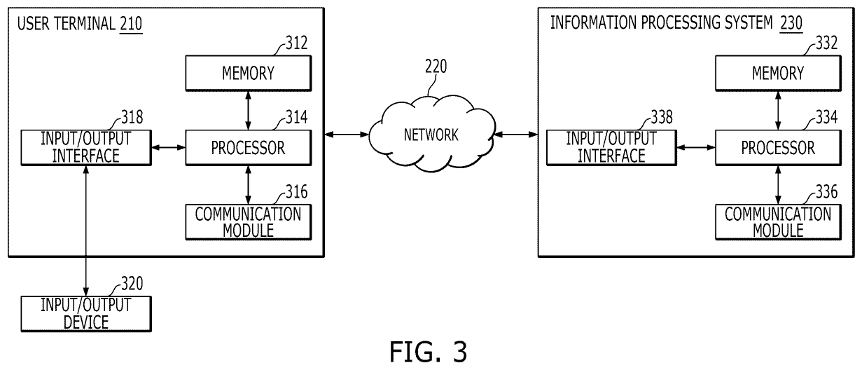

FIG. 3 is a block diagram illustrating internal configurations of a user terminal 210 and an information processing system 230. The user terminal 210 may refer to any computing device capable of running a data processing application or the like and performing wired/wireless communication, such as the mobile phone terminal 210_1, the tablet terminal 210_2, and the PC terminal 210_3 in FIG. 2. As illustrated, the user terminal 210 may include a memory 312, a processor 314, a communication module 316, and an input/output interface 318. Similarly, the information processing system 230 may include a memory 332, a processor 334, a communication module 336, and an input/output interface 338. As shown in FIG. 3, the user terminal 210 and the information processing system 230 may be configured to communicate information and/or data with each other via the communication modules 316 and 336 through the network 220. In addition, the input/output device 320 may be configured to input information and/or data to the user terminal 210 or output information and/or data generated by the user terminal 210 via the input/output interface 318.

The memories 312 and 332 may include non-transitory, computer-readable recording media of any kind. The memories 312 and 332 may include, for example, a permanent mass storage device such as a ROM (read-only memory), a disk drive, an SSD (solid state drive), or a flash memory. As another example, a permanent mass storage device such as a ROM, an SSD, a flash memory, or a disk drive may be included in a separate permanent storage device distinct from the memory, in the user terminal 210 or the information processing system 230. In addition, an operating system and at least one program code (e.g., code for an application associated with a data processing service) may be stored in the memories 312 and 332.

Such software components may be loaded from a separate computer-readable recording medium distinct from the memories 312 and 332. The separate computer-readable recording medium may include a computer-readable recording medium directly connectable to the user terminal 210 or the information processing system 230, such as a floppy drive, disk, tape, DVD/CD-ROM drive, or memory card. As another example, the software components may be loaded into the memories 312 and 332 through the communication modules 316 and 336 instead of from a computer-readable recording medium. For example, at least one program may be loaded into the memories 312 and 332 based on a computer program (e.g., an application associated with a data processing service) installed by files provided by a file distribution system that distributes installation files of the application via the network 220 to developers or to the user terminal for installation.

The processors 314 and 334 may be configured to process commands of a computer program by performing fundamental arithmetic, logic, and input/output operations. The commands may be provided to the processors 314 and 334 by the memories 312 and 332 or the communication modules 316 and 336. For example, the processors 314 and 334 may be configured to execute commands received according to program code stored in the memories 312 and 332, such as code for an operating system or an application.

The communication modules 316 and 336 may provide a configuration or function that enables the user terminal 210 and the information processing system 230 to communicate with each other via the network 220, and that enables the user terminal 210 and/or the information processing system 230 to communicate with other user terminals or other systems (e.g., separate cloud systems). For example, a request or data (for example, a request for data processing or data) generated by the processor 314 of the user terminal 210 according to program code stored in the memory 312 or the like may be transmitted to the information processing system 230 via the communication module 316 under its control and the network 220. Conversely, control signals or commands provided by the processor 334 of the information processing system 230 may be received by the user terminal 210 via the communication module 336, the network 220, and the communication module 316 of the user terminal 210.

The input/output interface 318 may be a means for interfacing with an input/output device 320. As an example, an input device may be a camera including an audio sensor and/or an image sensor, a keyboard, a microphone, a mouse, etc., and an output device may be a display, a speaker, a haptic feedback device, etc. As another example, the input/output interface 318 may be a means for interfacing with a device in which a configuration or function for input and output is integrated into a single device, such as a touchscreen. Although FIG. 3 shows the input/output device 320 as not being included in the user terminal 210, it is not limited thereto, and the user terminal 210 may be configured as a single device with it. Furthermore, the input/output interface 338 of the information processing system 230 may be a means for interfacing with an input device or an output device (not shown) that may be connected to or included in the information processing system 230. Although FIG. 3 illustrates the input/output interfaces 318 and 338 separately from the processors 314 and 334, respectively, they are not limited thereto, and the input/output interfaces 318 and 338 may be included in the processors 314 and 334.

The user terminal 210 and the information processing system 230 may include more components than those shown in FIG. 3. However, there is no need to explicitly illustrate most of the well-known technical components. The user terminal 210 may be implemented so that it includes at least some of the above-described input/output device(s) 320. In addition, the user terminal 210 may further include other components, such as a transceiver, a GPS (Global Positioning System) module, a camera, various sensors, or a database. For example, if the user terminal 210 is a smartphone, it may generally include the components of a smartphone, such as an accelerometer sensor, a gyro sensor, a microphone module, a camera module, various physical buttons, buttons using a touch panel, an input/output port, a vibrator for vibration, etc.

The processor 314 of the user terminal 210 may be configured to run a data processing application or a web browser application that provides a data processing service. In this case, program code associated with that application may be loaded into the memory 312 of the user terminal 210. While the application is running, the processor 314 of the user terminal 210 may receive information and/or data provided by the input/output device 320 through the input/output interface 318 or information and/or data from the information processing system 230 via the communication module 316, and may process such received information and/or data for storage in the memory 312. This information and/or data may also be provided to the information processing system 230 via the communication module 316.

While the data processing application is running, the processor 314 may receive, via an input device connected to the input/output interface 318, such as a touchscreen, a keyboard, a camera including an audio sensor and/or an image sensor, or a microphone, voice data, text, images, videos, etc. that are entered or selected, and may store the received voice data, text, images, and/or videos in the memory 312 or provide them to the information processing system 230 via the communication module 316 and the network 220. The processor 314 may receive a user input through the input device and, via the network 220 and the communication module 316, provide data/requests corresponding to the user input to the information processing system 230.

The processor 314 of the user terminal 210 may transmit information and/or data to the input/output device 320 via the input/output interface 318, causing such information and/or data to be output. For example, the processor 314 of the user terminal 210 may output processed information and/or data via an output device 320 capable of display output (e.g., a touchscreen, a display, etc.) or audio output (e.g., a speaker).

The processor 334 of the information processing system 230 may be configured to manage, process, and/or store information and/or data received from a plurality of user terminals 210 and/or a plurality of external systems. The information and/or data processed by the processor 334 may be provided to the user terminals 210 via the communication module 336 and the network 220.

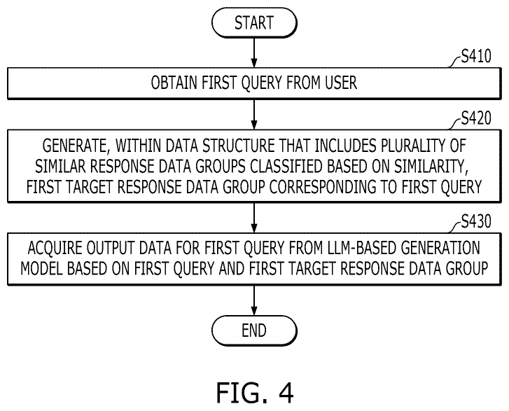

FIG. 4 is a diagram for describing a method for generating output data of a language model based on target information.

Referring to FIG. 4, the electronic device 100 may obtain a first query from a user (S410). In the present disclosure, the query may be text data, for example, text asking, “How much is the possible loan amount for an apartment in Cheonan?” or “What is the maximum mid-term loan available for an apartment?” to obtain a response based on target information.

The electronic device 100 may generate, within a data structure that includes a plurality of similar response data groups classified based on similarity, a first target response data group corresponding to the first query (S420). In the present disclosure, the “response data” may be text data provided to produce output data for the above type of query, such as a set of texts from a document describing loans or data about apartments in Cheonan. In the present disclosure, the term “response data” may be used interchangeably with terms such as “document” or “text chunk” to refer to a particular set of texts according to the description. The response data may be data provided along with the query so that the LLM-based neural network model can produce an accurate answer for the query. In other words, in the present disclosure, the response data may be the data exploration space provided together with the query so that the neural network model can derive a more accurate output.

In the present disclosure, a “similar response data group” is a set of response data that includes one or more pieces of response data, grouped by clustering according to the similarity of each piece of response data. The data structure of the present disclosure may include one or more such similar response data groups, and the structure and method of its generation will be described in detail below.

In the present disclosure, a “target response data group” is a set of texts (including one or more pieces of response data) that is provided to the language model along with the query.

Next, the electronic device 100 may acquire, from the LLM-based generation model, output data for the first query based on the first query and the first target response data group (S430). In the present disclosure, because the electronic device 100 inputs not only the query (i.e., the query text) but also a target response data group as target information together, the LLM-based generation model can produce a more accurate output.

In the present disclosure, the electronic device 100 may perform mathematical operations on text data by converting the text data into embedding vectors. Specifically, the electronic device 100 may perform tokenization, which divides the text data into units (tokens), and embedding, which converts each token into a vector value recognizable and processable by a computer. For example, the tokenization operation may use a technique such as Byte Pair Encoding (BPE). Generally, BPE is a technique in which words are divided into characters or Unicode units to form a vocabulary, and pairs of consecutive characters or Unicode units are merged in order of their frequency of appearance in the vocabulary to generate tokens. The embedding operation converts each token generated by the tokenization operation into an embedding vector, and it can be generated by various techniques such as Glove, FastText, or Word2Vec.

The electronic device 100 may generate a data structure including a plurality of similar response data groups.

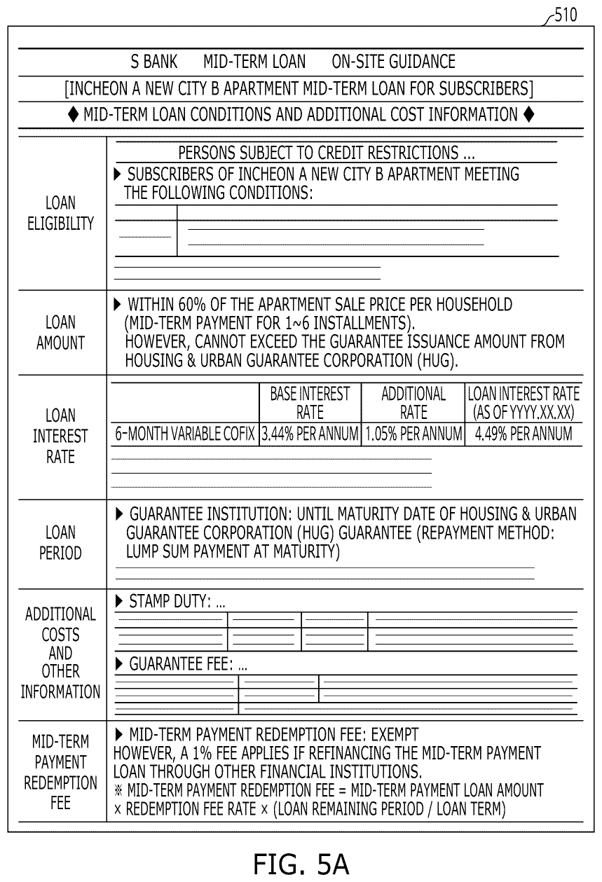

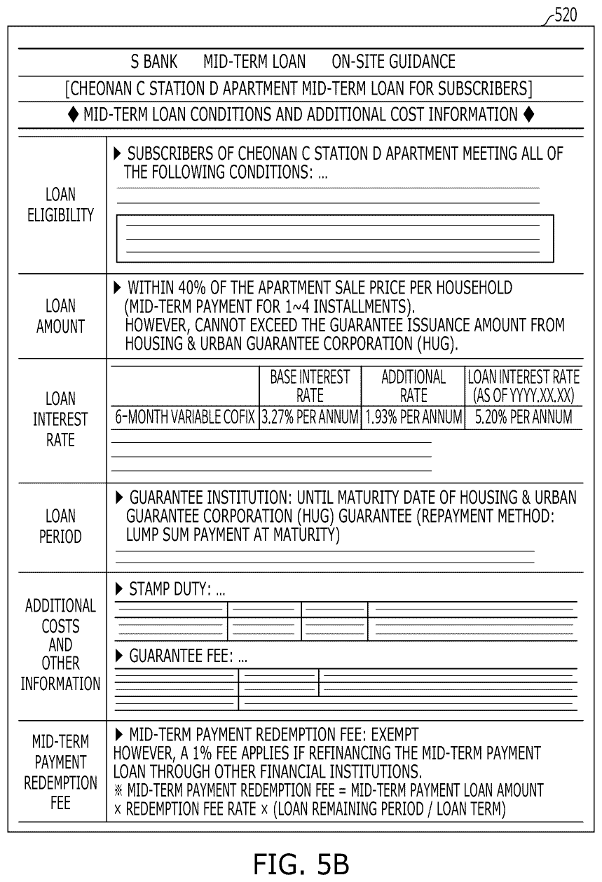

FIGS. 5A and 5B illustrate, by way of example, the response data (hereinafter referred to as documents) included in a particular similar response data group.

Referring to FIGS. 5A and 5B, both a first document 510 and a second document 520 relate to mid-term apartment loans, but they differ in detailed content such as interest rate, duration, and applicable targets.

In some implementations, the electronic device 100 may generate similar response data groups by generating embedding vectors for each document (510, 520) and calculating the similarity based on the generated vectors.

In a first example for generating a data structure that includes a plurality of similar response data groups, the electronic device 100 may calculate a similarity between a particular piece of response data and each of the remaining plural pieces of response data and generate the similar response data group based thereon.

Specifically, the electronic device 100 may calculate the similarity by using at least one of a Euclidean distance measurement, Manhattan distance measurement, Haversine distance measurement, Minkowski distance measurement, Mahalanobis distance measurement, cosine similarity measurement, or Jaccard similarity measurement. For example, the similarity can be computed by cosine similarity measurement, which can be expressed as shown in Equation (1) below:

$$Cosine Similarity = \frac{\vec{A} \cdot \vec{B}}{‖ \vec{A} ‖ ‖ \vec{B} ‖} \qquad Equation ( 1 )$$

In Equation (1), \vec{A} is the embedding vector for one piece of response data in the pair, and \vec{B} is the embedding vector for the other piece of response data. Suppose that the embedding vector for Document A is [1, 1, 1, 1, 1, 1, 1, 0, 0], and the embedding vector for Document B is [0, 0, 1, 1, 1, 1, 1, 1, 1]. The dot product of these two vectors is 5=(1×0)+ (1×0)+ (1×1)+ (1×1)+ (1×1)+ (1×1)+ (1×1)+ (0×1)+ (0×1), and the magnitude of each vector is \sqrt{7}, so the cosine similarity of the two vectors is 5/7.

The electronic device 100 may compare the cosine similarity calculated between a pair of documents to a predetermined threshold (i.e., a similarity threshold) and generate a similar response data group based on that. For example, suppose the similarity threshold is 0.7, and the cosine similarity between Response Data A and Response Data B is 0.9, and the cosine similarity between Response Data A and Response Data C is 0.5. Then the electronic device 100 may determine that Response Data A and Response Data B, which have a cosine similarity above the similarity threshold, are mutually similar. Response Data A may have additional similar response data beyond Response Data B, and these similar response data may form a single similar response data group.

Additionally, or alternatively, the electronic device 100 may calculate a similarity between a particular piece of response data and each of the remaining plural pieces of response data and generate the similar response data group based thereon. Specifically, the electronic device 100 may calculate the similarity by inputting each pair of response data consisting of a specific response data and one response data from the remaining multiple response data in the data structure to an LLM-based neural network model, thereby obtaining the similarity from the output of the neural network model. For example, the electronic device 100 may input Documents A and B, along with a query such as “Calculate the similarity between these two documents, returning 0 for entirely unrelated documents and 1 for identical documents,” into the LLM-based neural network model, thereby deriving the similarity value between the two documents.

Next, the electronic device 100 may generate the similar response data group by comparing the calculated similarity value to the predetermined threshold (i.e., the similarity threshold). For example, suppose the similarity threshold is 0.7, and the LLM-based neural network model outputs a similarity of 0.9 for Document A and Document B. Then the electronic device 100 may determine that Document A and Document B, which have a similarity above the similarity threshold, are mutually similar response data.

In a second example for generating a data structure that includes a plurality of similar response data groups, the electronic device 100 may generate the similar response data groups by calculating hash values based on similarity for each piece of the plural pieces of response data.

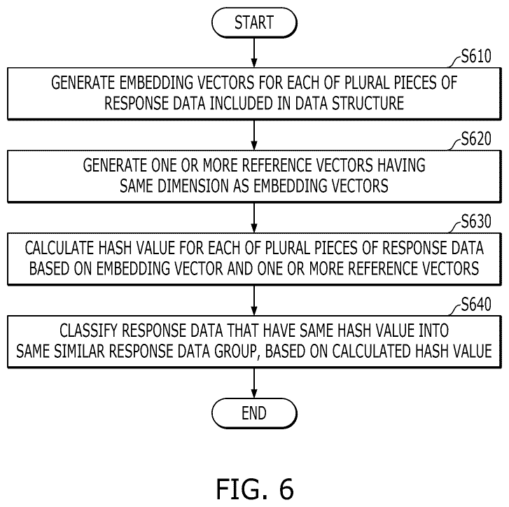

FIG. 6 is a diagram for describing a method for generating a data structure.

Referring to FIG. 6, the electronic device 100 may generate embedding vectors for each of the plural pieces of response data included in the data structure (S610). For example, suppose Document A corresponds to the embedding vector [1, 1, 1, 0, 0], Document B corresponds to [1, 0, 1, 0, 0], and Document C corresponds to [0, 0, 0, 1, 1].

Next, the electronic device 100 may generate one or more reference vectors having the same dimension as the embedding vectors (S620). The reference vectors may be arbitrary vectors in the space of the same dimension as the embedding vectors. For ease of explanation, assume there are two reference vectors: a first reference vector [0.5, −0.2, 0.7, 0.1, −0.4] and a second reference vector [−0.3, 0.6, 0.4, −0.1, 0.2].

Then the electronic device 100 may calculate, based on the embedding vector for each piece of response data and the one or more reference vectors, a hash value for each of the plural pieces of response data (S630). Specifically, the electronic device 100 may perform a dot product operation between the embedding vector for a particular piece of response data and each of the one or more reference vectors, and generate, according to the result of the dot product operation, a hash value having a length equal to the number of reference vectors. More specifically, the hash value for a particular piece of response data may be a string having a length equal to the number of reference vectors, with each position in the string corresponding to whether the dot product operation between the embedding vector of the particular piece of response data and one reference vector is positive or negative. If the result of the dot product operation is positive, the electronic device 100 may assign a 1 to the relevant position in the hash-value string, and if it is not positive, the electronic device 100 may assign a 0.

For example, the dot product between Document A's embedding vector [1, 1, 1, 0, 0] and the first reference vector [0.5, −0.2, 0.7, 0.1, −0.4] is 1=1×0.5+1×(−0.2)+1×0.7+0×0.1+0×(−0.4), which is positive, and the dot product between Document A's embedding vector and the second reference vector [−0.3, 0.6, 0.4, −0.1, 0.2] is 0.7=1× (−0.3)+1×0.6+1×0.4+0× (−0.1)+0×0.2, which is positive. Thus, Document A's hash value is “11.” Similarly, the dot product between Document B's embedding vector [1, 0, 1, 0, 0] and the first reference vector [0.5, −0.2, 0.7, 0.1, −0.4] is 1.2, which is positive, and the dot product between Document B's embedding vector and the second reference vector [−0.3, 0.6, 0.4, −0.1, 0.2] is 0.1, which is positive, so Document B's hash value is “11.” Meanwhile, the dot product between Document C's embedding vector [0, 0, 0, 1, 1] and the first reference vector [0.5, −0.2, 0.7, 0.1, −0.4] is −0.3, which is negative, and the dot product between Document C's embedding vector and the second reference vector [−0.3, 0.6, 0.4, −0.1, 0.2] is 0.1, which is positive, so Document C's hash value is “01.” That is, Document A's hash value is “11,” Document B's hash value is “11,” and Document C's hash value is “01.”

Next, the electronic device 100 may classify the pieces of response data that have the same (or identical) hash value into the same (or identical) similar response data group, based on the calculated hash value (S640). That is, documents having the same (or identical) hash value are placed in the same (or identical) similar response data group (or bucket) and recognized as similar documents. As described above, the number of reference vectors determines the length of the hash value, which determines the maximum possible number of groups of similar documents. In the present disclosure, two reference vectors were set for the sake of explanation, but this is not limiting and may be freely set.

In the data structure of the present disclosure, each of the plural similar response data groups included in the data structure may be stored in association with corresponding metadata. The metadata may be, for example, the folder name in which the documents of the similar response data group are stored, or it may be recorded and stored in a separate document that corresponds to the similar response data group.

In the present disclosure, the metadata may be composed of one or more main keywords included in a particular similar response data group. For example, the metadata may be text data such as “Incheon_Geomdan New City_Geumgang Pentarium_4.47_Cheonan_Dujeong Station_Bando U-Bora_5.20.”

In a first example of generating metadata, the electronic device 100 may obtain one or more main keywords by calculating, for each pair of similar response data, the term frequency of words in each piece of data, and extracting words that appear greater than or equal to a threshold frequency only in one of the documents. For example, suppose the threshold frequency is 10, and the term frequency calculated for Document A is {“contract deposit”: 11, “Cheonan”: 12, “bank”: 7} while that for Document B is {“contract deposit”: 11, “Dujeong”: 13, “bank”: 6}. In that case, the words in Document A appearing greater than or equal to 10 times are “contract deposit” and “Cheonan,” and among them, the word that appears only in Document A and not in Document B is “Cheonan.” Thus, the electronic device 100 may determine “Cheonan” as the main keyword for Document A. Also, the words in Document B appearing greater than or equal to 10 times are “contract deposit” and “Dujeong,” and among them, the word that appears only in Document B and not in Document A is “Dujeong.” Hence, the electronic device 100 may determine “Dujeong” as the main keyword for Document B. Accordingly, the electronic device 100 may include both “Cheonan” and “Dujeong” as main keywords in the metadata of the similar response data group containing Documents A and B.

Furthermore, even for the same document, depending on which other document is used for comparison, different keywords may be extracted, and the metadata for the similar response data group may include all such keywords as main keywords. For example, suppose Document A's term frequency is {“contract deposit”: 11, “Cheonan”: 12, “bank”: 7}, while Document C's term frequency is {“loan amount”: 9, “apartment”: 5, “penalty”: 11}. Then, comparing Document A and Document C, “contract deposit,” which appears at least 10 times in Document A, does not appear in Document C, so it may be extracted as a main keyword for Document A. Similarly, “penalty” may be extracted as a main keyword for Document C. Therefore, the electronic device 100 may add “contract deposit” and “penalty” to the metadata of the similar response data group.

As a result, in the first example related to metadata generation, the metadata of the similar response data group described above may include ‘Cheonan,’ ‘Dujeong,’ ‘deposit,’ and ‘penalty’ as primary keywords.

In a second example of generating metadata, the electronic device 100 may generate main keywords by inputting the response data included in a particular similar response data group into an LLM-based neural network model, thereby generating metadata.

For example, the electronic device 100 can extract main keywords by inputting the query ‘Extract keywords that uniquely exist or appear more frequently in each document compared to the others’ along with the documents included in the specific similar response data group, and thereby generate the metadata.

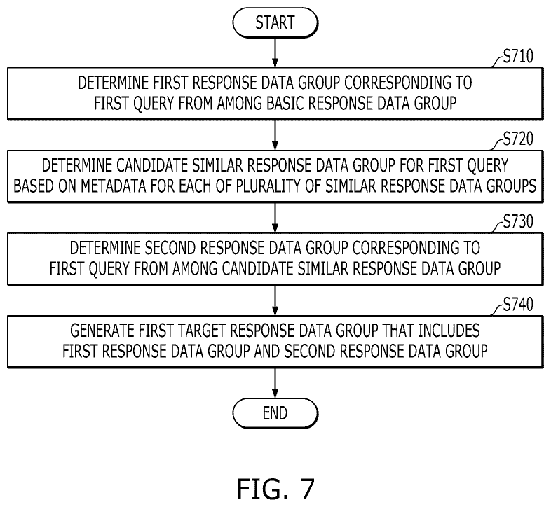

FIG. 7 is a diagram illustrating, by way of example, the process of generating a target response data group.

The electronic device 100 may determine a first response data group corresponding to the first query from among the basic response data group included in the data structure (S710).

In the present disclosure, the “basic response data group” may be a data group that includes documents to be mandatorily searched for similar response data in response to the query. For example, the electronic device 100 may compare the embedding vector of the query with the embedding vectors of each document included in the basic response data group, extract those documents having a similarity greater than or equal to a threshold (ta), and determine a first response data group (D_{default}) composed of the extracted documents.

Next, the electronic device 100 may determine a candidate similar response data group for the first query based on the metadata for each of the plurality of similar response data groups (S720). Specifically, the electronic device 100 may compare the embedding vector of the query not with the embedding vectors of individual documents, but with the embedding vectors of the metadata corresponding to each of the similar response data groups, thereby determining the candidate similar response data group. For example, suppose the query is “How much mid-term loan is available for an apartment in redevelopment zone (1-2) in Cheonan?” Suppose also that there is a first similar response data group having metadata “Cheonan_Dujeong_mid-term_loan,” and a second similar response data group having metadata “Gangnam_Daechi_building sale.” Then the electronic device 100 may determine that the first similar response data group has metadata similar to the query by comparing embedding vectors and decide that it is a candidate similar response data group.

Next, the electronic device 100 may determine a second response data group corresponding to the first query in the candidate similar response data group (S730). By comparing the embedding vector of the query with the embedding vectors of each document included in the candidate similar response data group, the electronic device 100 may extract those documents having a similarity greater than or equal to a threshold (t_{b}) and determine a second response data group (D_{folder}) composed of the extracted documents.

The electronic device 100 may generate a first target response data group that includes the first response data group (D_{default}) and the second response data group (D_{folder}) (S740). The first target response data group may be a response data group that is the union (D_{default} ∪D_{folder}) of the first response data group and the second response data group. The first target response data group is the data inputted to the LLM-based generation model along with the first query, and may be the target information for the first query, enabling more accurate output data to be obtained.

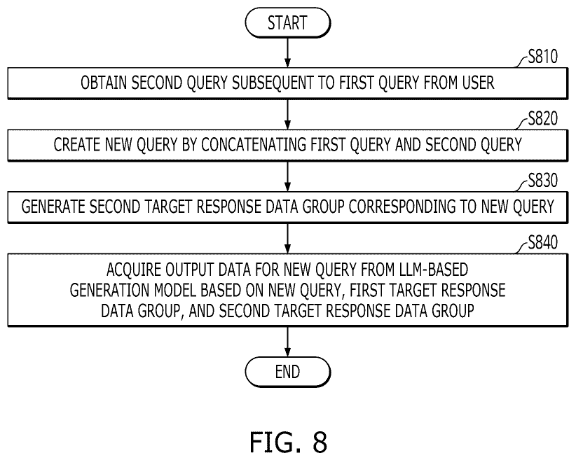

FIG. 8 is a diagram for describing a method for generating output data for a second query subsequent to a first query.

Referring to FIG. 8, suppose that a first target response data group has already been generated for the preceding first query, as described with reference to FIG. 7.

The electronic device 100 may obtain from the user a second query subsequent to the first query (S810). The second query may be an additional question that maintains the same context as the first query. For example, if the first query is “How much mid-term loan is available for an apartment in redevelopment zone (1-2) in Cheonan?,” the second query may be text such as “What is the interest rate for the loan?”

The electronic device 100 may create a new query by concatenating (i.e., attaching) the first query and the second query (S820). That is, the new query may be “How much mid-term loan is available for an apartment in redevelopment zone (1-2) in Cheonan? What is the interest rate for the loan?”

Next, the electronic device 100 may generate a second target response data group corresponding to the new query (S830). The method of generating the second target response data group for the new query may be the same as or similar to the method of generating the first target response data group for the first query. That is, the electronic device 100 may generate a second target response data group that includes a third response data group

$$( {D}_{default}^{′} )$$

and a forth response data group

$$( {D}_{folder}^{′} )$$

corresponding to the new query.

The electronic device 100 may acquire output data for the new query from the LLM-based generation model based on the new query, the first target response data group, and the second target response data group (S840). Specifically, the electronic device 100 may generate output data for the new query by using the document set

$$( {D}_{default} ⋃ {D}_{folder} ⋃ {D}_{default}^{′} ⋃ {D}_{folder}^{′} ) ,$$

which is the union of the first target response data group and the second target response data group. In other words, for the new query that includes the first query and the second query, the electronic device 100 may effectively provide both the first target response data group and the second target response data group to the LLM-based generation model so as to maintain the context of the first query while effectively generating answers to additional questions that appear in the second query.

In an additional example of the present disclosure, if a third query is input subsequent to the second query, the electronic device 100 may again create a new query by concatenating the second query and the third query (excluding the first query), generate a second target response data group and a third target response data group for that new query, and thereby produce the input data for the LLM-based language model. This process may be repeated N times (N being a natural number greater than or equal to 1).

In a conventional method, if the second query is answered without considering the context of the first query, then in the example above—where the second query is “What is the loan interest rate?”—the LLM-based neural network model might provide an interest rate from a different document or a general interest rate. In contrast, the present disclosure can more effectively generate an accurate answer by concatenating the first query with the second query into a single new query and providing the corresponding target information.

Moreover, if multiple subsequent queries are always concatenated, and the context changes (for example, from asking about loan information for a particular region to asking about a different region), retaining excessive prior context may produce incorrect output data. On the other hand, the present disclosure is flexible in responding to such a change in context by concatenating only the immediately preceding query and the current query.

In an additional example of the present disclosure, the electronic device 100 may receive additional input from the user regarding information on a user-designated folder. In such a case, the electronic device 100 may also retrieve similar response data from the response data group included in the user-designated folder and use it as target information. That is, if the electronic device 100 has received information about a user-designated folder, it may generate a target response data group (D_{default} ∪D_{folder} ∪Dᵤₛₑᵣ) that includes, in addition to the first response data group (D_{default}) generated from the basic response data group and the second response data group (D_{folder}) generated from the similar response data group, a third response data group (Dᵤₛₑᵣ) generated from the response data group included in the user-designated folder.

In another example of the present disclosure, if the target response data group generated for the first query is an empty set, the electronic device 100 may determine that the input first query is “cannot be answered from the given documents (Out of Domain).”

In yet another example of the present disclosure, if the target response data group generated for the first query and the second query is an empty set, the electronic device 100 may compare the first query with all the documents included in the data structure to generate a first set of documents (Dₐₗₗ) having a similarity greater than or equal to a threshold (t_{b}), and compare the second query with all the documents included in the data structure to generate a second set of documents

$$( {D}_{all}^{′} )$$

having a similarity greater than or equal to that threshold. If the union of (Dₐₗₗ) and

$$( {D}_{all}^{′} )$$

is empty, the electronic device 100 may determine that the combined question formed by the first query and the subsequent second query “cannot be answered from the given documents (Out of Domain).” If the union of (Dₐₗₗ) and

$$( {D}_{all}^{′} )$$

is not empty, the electronic device 100 may determine that “additional information is required (Insufficient Information)” to answer the question formed by the first query and the subsequent second query.

The flowchart and description above are merely examples and may be implemented differently in some examples. For example, in some examples, the order of respective steps may be changed, some steps may be repeatedly performed, some steps may be omitted, or some steps may be added.

The method described above may be provided as a computer program stored in a computer-readable recording medium for execution on a computer. The medium may be a type of medium that continuously stores a program executable by a computer, or temporarily stores the program for execution or download. In addition, the medium may be a variety of recording means or storage means having a single piece of hardware or a combination of several pieces of hardware, and is not limited to a medium that is directly connected to any computer system, and accordingly, may be present on a network in a distributed manner. An example of the medium includes a medium configured to store program instructions, including a magnetic medium such as a hard disk, a floppy disk, and a magnetic tape, an optical medium such as a CD-ROM and a DVD, a magnetic-optical medium such as a floptical disk, and a ROM, a RAM, a flash memory, etc. In addition, other examples of the medium may include an app store that distributes applications, a site that supplies or distributes various software, and a recording medium or a storage medium managed by a server.

The methods, operations, or techniques of the present disclosure may be implemented by various means. For example, these techniques may be implemented in hardware, firmware, software, or a combination thereof. Those skilled in the art will further appreciate that various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies depending on design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, computer, or a combination thereof.

Accordingly, various example logic blocks, modules, and circuits described in connection with the present disclosure may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any related processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage devices, etc. The instructions may be executable by one or more processors, and may cause the processor(s) to perform certain aspects of the functions described in the present disclosure.

When implemented in software, the techniques may be stored on a computer-readable medium as one or more instructions or codes, or may be transmitted through a computer-readable medium. The computer-readable media include both the computer storage media and the communication media including any medium that facilitates the transmission of a computer program from one place to another. The storage media may also be any available media that may be accessible to a computer. By way of non-limiting example, such a computer-readable medium may include RAM, ROM, EEPROM, CD-ROM or other optical disk storage, magnetic disk storage or other magnetic storage devices, or any other media that can be used to transmit or store desired program code in the form of instructions or data structures and can be accessible to a computer. In addition, any connection is properly referred to as a computer-readable medium.

For example, if the software is sent from a website, server, or other remote sources using coaxial cable, fiber optic cable, twisted pair, digital subscriber line (DSL), or wireless technologies such as infrared, wireless, and microwave, the coaxial cable, the fiber optic cable, the twisted pair, the digital subscriber line, or the wireless technologies such as infrared, wireless, and microwave are included within the definition of the medium. The disks and the discs used herein include CDs, laser disks, optical disks, digital versatile discs (DVDs), floppy disks, and Blu-ray disks, where disks usually magnetically reproduce data, while discs optically reproduce data using a laser. The combinations described above should also be included within the scope of the computer-readable media.

The software module may reside in RAM memory, flash memory, ROM memory, EPROM memory, EEPROM memory, registers, hard disk, removable disk, CD-ROM, or any other form of storage medium known. An exemplary storage medium may be connected to the processor such that the processor may read or write information from or to the storage medium. Alternatively, the storage medium may be integrated into the processor. The processor and the storage medium may exist in the ASIC. The ASIC may exist in the user terminal. Alternatively, the processor and storage medium may exist as separate components in the user terminal.

Although the examples described above have been described as utilizing aspects of the currently disclosed subject matter in one or more standalone computer systems, aspects are not limited thereto, and may be implemented in conjunction with any computing environment, such as a network or distributed computing environment. Furthermore, the aspects of the subject matter in the present disclosure may be implemented in multiple processing chips or apparatus, and storage may be similarly influenced across a plurality of apparatus. Such apparatus may include PCs, network servers, and portable apparatus.

Although the present disclosure has been described in connection with some examples herein, various modifications and changes can be made without departing from the scope of the present disclosure, which can be understood by those skilled in the art to which the present disclosure pertains. In addition, such modifications and changes should be considered within the scope of the claims appended herein.

What is claimed is:

1. A method performed by an electronic device comprising at least one processor, the method comprising:
obtaining, based on a user input, a first query;
generating, within a data structure that includes a plurality of similar response data groups classified based on similarity, a first target response data group corresponding to the first query;
acquiring output data for the first query from a large language model (LLM)-based generation model, wherein the output data for the first query is acquired based on the first query and the first target response data group; and
outputting the acquired output data for the first query.

2. The method according to claim 1, further comprising generating the data structure,
wherein the generating of the data structure comprises:
calculating a similarity between a particular piece of response data included in the data structure and each of a plurality of remaining pieces of response data included in the data structure; and
generating the plurality of similar response data groups by comparing the calculated similarity with a predetermined threshold.

3. The method according to claim 2, wherein the calculating of the similarity comprises:
generating embedding vectors for the particular piece of response data and for each of the plurality of remaining pieces of response data; and
calculating a similarity between an embedding vector for the particular piece of response data and an embedding vector for each of the plurality of remaining pieces of response data.

4. The method according to claim 2, wherein the calculating of the similarity comprises:
inputting a pair of pieces of response data into an LLM-based neural network model to calculate the similarity through an output of the LLM-based neural network model.

5. The method according to claim 1, further comprising generating the data structure,
wherein the generating of the data structure comprises:
generating an embedding vector for each of a plurality of pieces of response data included in the data structure;
generating one or more reference vectors having a same dimension as the embedding vector;
calculating, based on the embedding vector and the one or more reference vectors, a hash value for each of the plurality of pieces of response data; and
classifying, based on the calculated hash value, response data having an identical hash value into an identical similar response data group.

6. The method according to claim 5, wherein the calculating of the hash value for each of the plurality of pieces of response data comprises:
performing a dot product operation between an embedding vector for a particular piece of response data and each of the one or more reference vectors; and
generating, based on a result of the dot product operation, a hash value having a length corresponding to a number of the one or more reference vectors.

7. The method according to claim 1, wherein the plurality of similar response data groups included in the data structure are each stored in association with corresponding metadata.

8. The method according to claim 7, wherein the metadata comprises one or more main keywords included in a particular similar response data group.

9. The method according to claim 8, wherein the one or more main keywords are obtained by:
calculating a term frequency of words in each piece of response data included in the particular similar response data group and extracting words whose calculated term frequency is greater than or equal to a threshold term frequency.

10. The method according to claim 8, wherein the one or more main keywords are obtained by inputting response data included in the particular similar response data group into an LLM-based neural network model to derive keywords.

11. The method according to claim 1, wherein the data structure further comprises a basic response data group, and
wherein the generating of the first target response data group comprises:
determining a first response data group corresponding to the first query from among the basic response data group;
determining, based on metadata for each of the plurality of similar response data groups, a candidate similar response data group for the first query;
determining a second response data group corresponding to the first query from among the candidate similar response data group; and
generating the first target response data group, wherein the first target response data group comprises the first response data group and the second response data group.

12. The method according to claim 1, further comprising:
obtaining, based on the user input, a second query subsequent to the first query;
generating a new query by concatenating the first query and the second query;
generating a second target response data group corresponding to the new query; and
acquiring output data for the new query from the LLM-based generation model, wherein the output data for the new query is acquired based on the new query, the first target response data group, and the second target response data group.

13. A non-transitory computer-readable recording medium storing computer-readable instructions, wherein the computer-readable instructions, when executed by at least one processor, cause an electronic device to:
obtain, based on a user input, a first query;
generate, within a data structure that includes a plurality of similar response data groups classified based on similarity, a first target response data group corresponding to the first query;
acquire output data for the first query from a large language model (LLM)-based generation model, wherein the output data for the first query is acquired based on the first query and the first target response data group; and
output the acquired output data for the first query.

14. An electronic device, comprising:
a memory storing computer-readable instructions; and
at least one processor connected to the memory and configured to execute the computer-readable instructions,
wherein the computer-readable instructions, when executed, are configured to cause the electronic device to:
obtain, based on a user input, a first query;
generate, within a data structure that includes a plurality of similar response data groups classified based on similarity, a first target response data group corresponding to the first query;
acquire output data for the first query from a large language model (LLM)-based generation model, wherein the output data for the first query is acquired based on the first query and the first target response data group; and
output the acquired output data for the first query.

15. The electronic device according to claim 14, wherein the computer-readable instructions, when executed, are configured to cause the electronic device to:
calculate a similarity between a particular piece of response data included in the data structure and each of a plurality of remaining pieces of response data included in the data structure; and
generate the plurality of similar response data groups by comparing the calculated similarity with a predetermined threshold thereby generating the data structure.

16. The electronic device according to claim 15, wherein the computer-readable instructions, when executed, are configured to cause the electronic device to:
generate embedding vectors for the particular piece of response data and for each of the plurality of remaining pieces of response data; and
calculate a similarity between an embedding vector for the particular piece of response data and an embedding vector for each of the plurality of remaining pieces of response data.

17. The electronic device according to claim 14, wherein the computer-readable instructions, when executed, are configured to cause the electronic device to:
generate an embedding vector for each of a plurality of pieces of response data included in the data structure;
generate one or more reference vectors having a same dimension as the embedding vectors;
calculate, based on the embedding vector and the one or more reference vectors, a hash value for each of the plurality of pieces of response data; and
classify, based on the calculated hash value, response data having an identical hash value into an identical similar response data group thereby generating the data structure.

18. The electronic device according to claim 14, wherein the plurality of similar response data groups included in the data structure are each stored in association with corresponding metadata in the memory, and the metadata comprises one or more main keywords included in a particular similar response data group.

19. The electronic device according to claim 18, wherein the one or more main keywords are obtained by:
calculating a term frequency of words in each piece of response data included in the particular similar response data group and extracting words whose calculated term frequency is greater than or equal to a threshold term frequency, or
inputting the response data included in the particular similar response data group into an LLM-based neural network model to derive keywords.

20. The electronic device according to claim 14, wherein the computer-readable instructions, when executed, are configured to cause the electronic device to:
obtain, based on the user input, a second query subsequent to the first query;
generate a new query by concatenating the first query and the second query;
generate a second target response data group corresponding to the new query; and
acquire output data for the new query from the LLM-based generation model, wherein the output data for the new query is acquired based on the new query, the first target response data group, and the second target response data group.
